(19) United States
(12) Patent Application Publication
(10) Pub. No.: US 2012/0229970 A1
(43) Pub. Date: Sep. 13, 2012

(54) Box for Placing and Supporting a Tablet PC on a Table

(76) Inventor: Mao-Jung Hsu, Taichung City (TW)

(21) Appl. No.: 13/045,633

(22) Filed: Mar. 11, 2011

(51) Int. Cl. G06F 1/16

(52) U.S. Cl. 361/679.09

(57) ABSTRACT

A box includes a receiving seat adapted for supporting a keyboard, a mounting seat pivotally connected with the receiving seat, a support rack pivotally mounted on the mounting seat and adapted for supporting a tablet PC, and a support leg mounted between the mounting seat and the support rack to lift the support rack. Thus, when the box is opened, the keyboard is received in the receiving seat, and the tablet PC is supported by the support rack in an inclined manner so that when the box is placed on a table, the tablet PC co-operates with the keyboard to function as a table PC, thereby facilitating a user operating the tablet PC on the table.

### BACKGROUND OF THE INVENTION

1. Field of the Invention

The present invention relates to a box and, more particularly, to a box for storing and carrying a tablet PC (personal computer), such as an iPAD and the like.

2. Description of the Related Art

A conventional tablet PC, such as an iPAD and the like, comprises a touch screen using a digitizing technology so that a user can touch the touch screen by his/her finger so as to operate the tablet PC directly and easily. The conventional tablet PC also comprises a touch keyboard to facilitate the user operating the tablet PC. However, when the tablet PC is placed on a table, the tablet PC cannot function as a table PC, thereby limiting the versatility of the tablet PC.

### BRIEF SUMMARY OF THE INVENTION

In accordance with the present invention, there is provided a box for a tablet PC (personal computer), comprising a receiving seat adapted for supporting a keyboard, a mounting seat pivotally connected with the receiving seat, a support rack pivotally mounted on the mounting seat and adapted for supporting a tablet PC, and a support leg mounted between the mounting seat and the support rack to lift the support rack.

The primary objective of the present invention is to provide a box for placing and supporting a tablet PC on a table.

According to the primary advantage of the present invention, when the box is opened, the keyboard is received in the receiving seat, and the tablet PC is supported by the support rack in an inclined manner so that when the box is placed on a table, the tablet PC co-operates with the keyboard to function as a table PC, thereby facilitating a user operating the tablet PC on the table.

According to another advantage of the present invention, the box can be folded to have a smaller volume to facilitate the user carrying the box.

According to a further advantage of the present invention, the box can be folded and expanded easily and quickly, thereby facilitating the user using the box.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a box for a tablet PC in accordance with the preferred embodiment of the present invention.

FIG. 2 is an exploded perspective view of the box for a tablet PC as shown in FIG. 1.

FIG. 3 is a perspective expanded view of the box for a tablet PC as shown in FIG. 1.

FIG. 4 is a schematic operational view of the box for a tablet PC as shown in FIG. 3 in use.

FIG. 5 is a top exploded folded view of the box for a tablet PC as shown in FIG. 3.

### DETAILED DESCRIPTION OF THE INVENTION

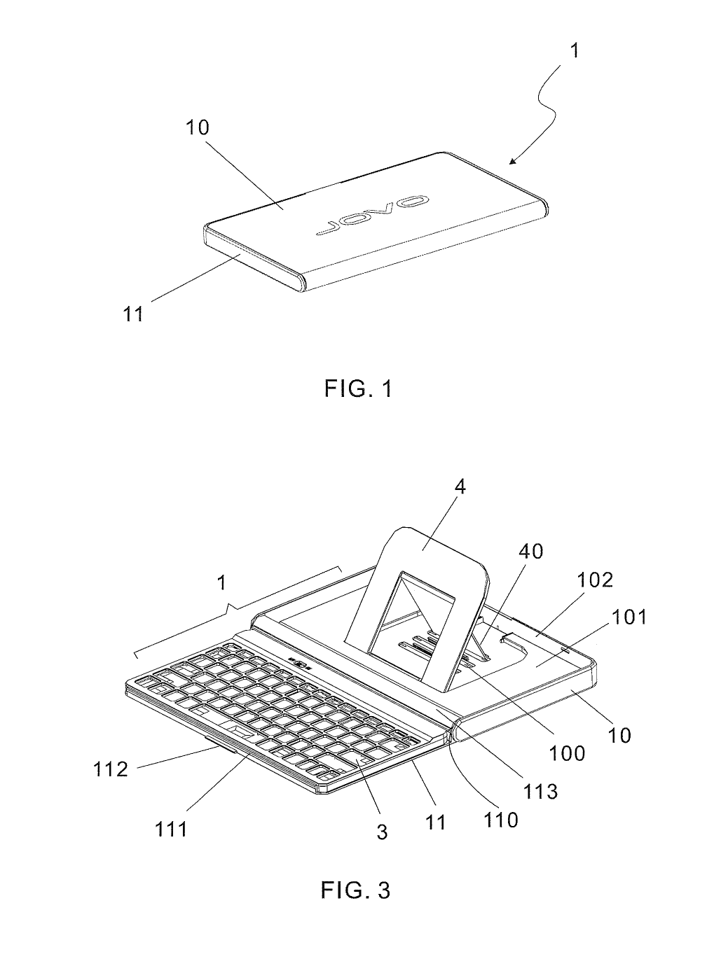

Referring to FIGS. 1-5, a box 1 for a tablet PC in accordance with the preferred embodiment of the present invention comprises a receiving seat 11 adapted for supporting a keyboard 3, a mounting seat 10 pivotally connected with the receiving seat 11, a support rack 4 pivotally mounted on the mounting seat 10 and adapted for supporting a tablet PC 2, a support leg 40 mounted between the mounting seat 10 and the support rack 4 to lift the support rack 4, and a cushion 101 mounted on the mounting seat 10 and surrounding the support rack 4 and the support leg 40.

The mounting seat 10 has an inner face provided with a plurality of adjusting slots 100 for mounting the support leg 40. The adjusting slots 100 of the mounting seat 10 are parallel with each other. Each of the adjusting slots 100 of the mounting seat 10 has an elongate shape. The mounting seat 10 has a hollow inside provided with a mounting space 102 for mounting the cushion 101, the support rack 4 and the support leg 40.

The support rack 4 is inclined relative to the mounting seat 10 and has a first end pivotally connected with the mounting seat 10 and a second end pivotally connected with the support leg 40.

The support leg 40 is inclined relative to the mounting seat 10 and is combined with the support rack 4 to form a substantially inverted V-shaped support structure that is adapted for supporting the tablet PC 2. The support leg 40 has a first end pivotally connected with the mounting seat 10 and a second end pivotally connected with the second end of the support rack 4. Preferably, the first end of the support leg 40 is pivotally mounted in one of the adjusting slots 100 of the mounting seat 10 to adjust an inclined angle of the support rack 4 relative to the mounting seat 10.

The receiving seat 11 has an inner face provided with a receiving chamber 110 that is adapted for receiving the keyboard 3. The receiving seat 11 has a front side provided with a flexible stop wall 111 that is adapted for positioning the keyboard 3. The stop wall 111 of the receiving seat 11 has a surface provided with a protruding handle 112 to facilitate a user pulling the keyboard 3 from the receiving chamber 110 of the receiving seat 11. The receiving seat 11 has a rear side provided with a pivot portion 113 pivotally connected with the mounting seat 10. The pivot portion 113 of the receiving seat 11 is received in the mounting space 102 of the mounting seat 10. The pivot portion 113 of the receiving seat 11 is adapted for locating the keyboard 3 and is adapted for stopping the tablet PC 2. The receiving chamber 110 of the receiving seat 11 is disposed between the stop wall 111 and the pivot portion 113 of the receiving seat 11.

The keyboard 3 is snapped into the receiving chamber 110 of the receiving seat 11 and is located between the stop wall 111 and the pivot portion 113 of the receiving seat 11. The keyboard 3 is connected with the tablet PC 2 in a wireless transmission way. Preferably, the keyboard 3 is connected with the tablet PC 2 in a bluetooth transmission way.

The tablet PC 2 has a back face supported by the support rack 4 and has a lower end abutting the pivot portion 113 of the receiving seat 11.

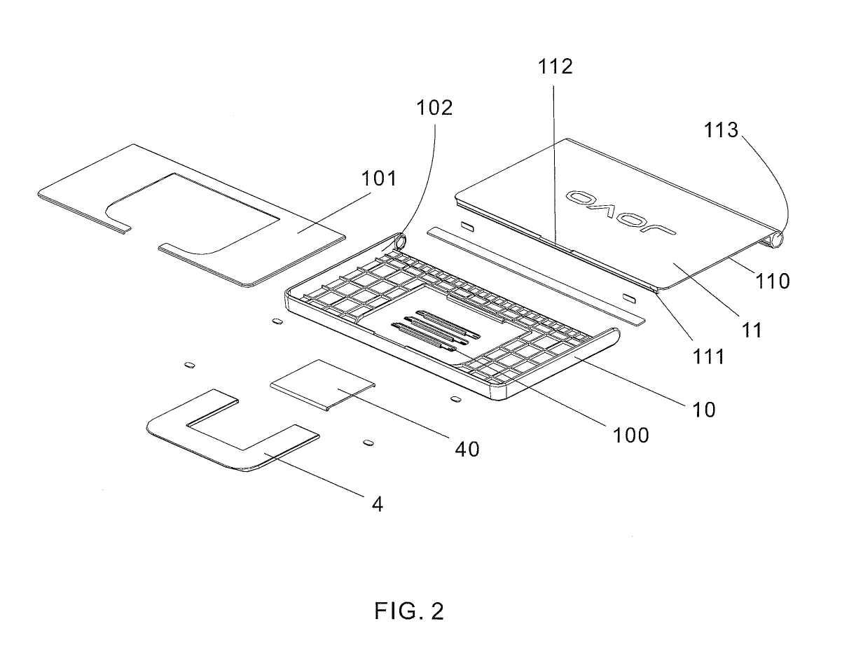

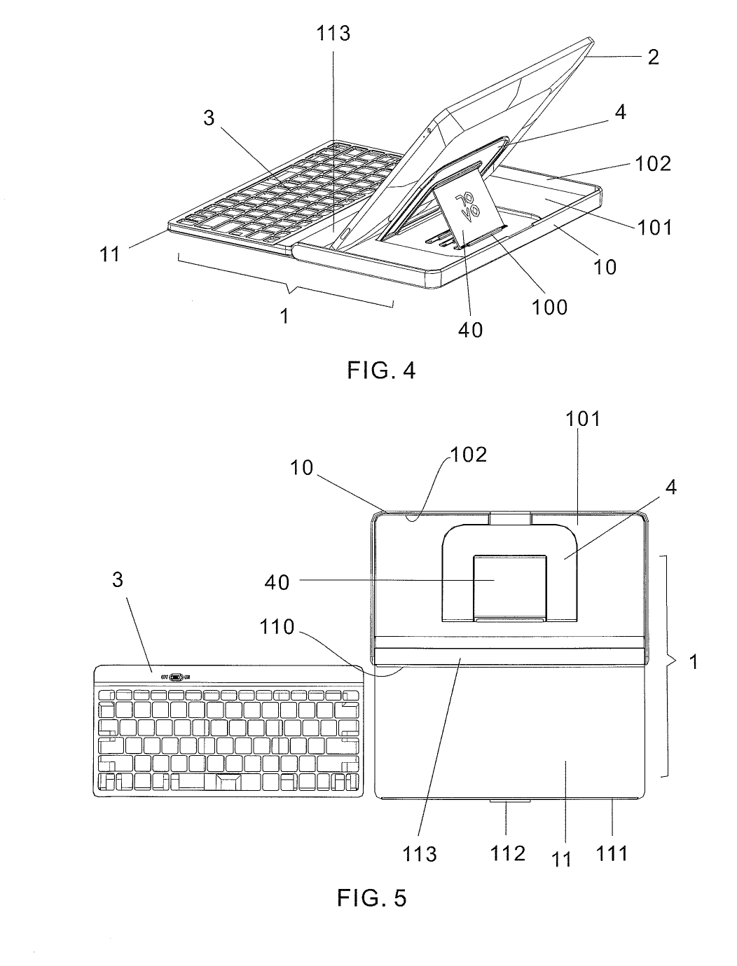

In operation, referring to FIGS. 3-5 with reference to FIGS. 1 and 2, the mounting seat 10 is pivoted outward relative to the receiving seat 11 to open the box 1 as shown in FIG. 5. Then, the keyboard 3 is placed into and received in the receiving chamber 110 of the receiving seat 11 as shown in FIG. 3. Then, the support rack 4 is moved and pivoted upward relative to the mounting seat 10, and the support leg 40 is locked onto one of the adjusting slots 100 of the mounting seat 10 so that the support rack 4 and the support leg 40 are combined to form the support structure as shown in FIG. 3. Then, the tablet PC 2 is placed on the mounting seat 10 and supported by the support rack 4 in an inclined manner as shown in FIG. 4. In such a manner, when the box 1 is placed on a table, the tablet PC 2 co-operates with the keyboard 3 to function as a table PC.

Accordingly, when the box 1 is opened, the keyboard 3 is received in the receiving seat 11, and the tablet PC 2 is supported by the support rack 4 in an inclined manner so that when the box 1 is placed on a table, the tablet PC 2 co-operates with the keyboard 3 to function as a table PC, thereby facilitating a user operating the tablet PC 2 on the table. In addition, the box 1 can be folded to have a smaller volume to facilitate the user carrying the box 1. Further, the box 1 can be folded and expanded easily and quickly, thereby facilitating the user using the box 1.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A box for a tablet PC (personal computer), comprising:
a receiving seat adapted for supporting a keyboard;
a mounting seat pivotally connected with the receiving seat;
a support rack pivotally mounted on the mounting seat and adapted for supporting a tablet PC; and
a support leg mounted between the mounting seat and the support rack to lift the support rack.

2. The box for a tablet PC of claim 1, wherein the box further comprises:
a cushion mounted on the mounting seat and surrounding the support rack 4 and the support leg.

3. The box for a tablet PC of claim 1, wherein the receiving seat has an inner face provided with a receiving chamber that is adapted for receiving the keyboard.

4. The box for a tablet PC of claim 3, wherein the receiving seat has a front side provided with a flexible stop wall that is adapted for positioning the keyboard.

5. The box for a tablet PC of claim 4, wherein the receiving seat has a rear side provided with a pivot portion pivotally connected with the mounting seat.

6. The box for a tablet PC of claim 5, wherein the pivot portion of the receiving seat is adapted for locating the keyboard.

7. The box for a tablet PC of claim 5, wherein the pivot portion of the receiving seat is adapted for stopping the tablet PC.

8. The box for a tablet PC of claim 5, wherein
the mounting seat has a hollow inside provided with a mounting space;
the pivot portion of the receiving seat is received in the mounting space of the mounting seat.

9. The box for a tablet PC of claim 2, wherein the mounting seat has a hollow inside provided with a mounting space for mounting the cushion, the support rack and the support leg.

10. The box for a tablet PC of claim 5, wherein the receiving chamber of the receiving seat is disposed between the stop wall and the pivot portion of the receiving seat.

11. The box for a tablet PC of claim 10, wherein the keyboard is snapped into the receiving chamber of the receiving seat and is located between the stop wall and the pivot portion of the receiving seat.

12. The box for a tablet PC of claim 1, wherein the keyboard is connected with the tablet PC in a wireless transmission way.

13. The box for a tablet PC of claim 12, wherein the keyboard is connected with the tablet PC in a bluetooth transmission way.

14. The box for a tablet PC of claim 5, wherein the tablet PC has a back face supported by the support rack and has a lower end abutting the pivot portion of the receiving seat.

15. The box for a tablet PC of claim 1, wherein
the support rack is inclined relative to the mounting seat and has a first end pivotally connected with the mounting seat and a second end pivotally connected with the support leg;
the support leg has a first end pivotally connected with the mounting seat and a second end pivotally connected with the second end of the support rack.

16. The box for a tablet PC of claim 15, wherein
the mounting seat has an inner face provided with a plurality of adjusting slots for mounting the support leg;
the first end of the support leg is pivotally mounted in one of the adjusting slots of the mounting seat to adjust an inclined angle of the support rack relative to the mounting seat.

17. The box for a tablet PC of claim 16, wherein the support leg is inclined relative to the mounting seat and is combined with the support rack to form a substantially inverted V-shaped support structure that is adapted for supporting the tablet PC.

18. The box for a tablet PC of claim 16, wherein the adjusting slots of the mounting seat are parallel with each other.

19. The box for a tablet PC of claim 16, wherein each of the adjusting slots of the mounting seat has an elongate shape.

20. The box for a tablet PC of claim 4, wherein the stop wall of the receiving seat has a surface provided with a protruding handle to facilitate a user pulling the keyboard from the receiving chamber of the receiving seat.
